(19) United States
(12) Patent Application Publication
(10) Pub. No.: US 2021/0364161 A1
(43) Pub. Date: Nov. 25, 2021

(54) Multi-purpose Light Bulb

(71) Applicant: Donald Acker, Barrow, AK (US)

(72) Inventor: Donald Acker, Barrow, AK (US)

(21) Appl. No.: 16/992,844

(22) Filed: Aug. 13, 2020

Related U.S. Application Data
(60) Provisional application No. 63/028,655, filed on May 22, 2020.

(51) Int. Cl. F21V 33/00; F21V 3/00; F21V 23/04; F21S 43/19; B60Q 9/00; B60R 16/033; B60Q 1/30

(52) U.S. Cl. CPC F21V 33/0056; F21V 3/00; F21V 23/0435; F21Y 2115/10; B60Q 9/00; B60R 16/033; B60Q 1/30; F21S 43/195

(57) ABSTRACT

A multi-purpose light bulb is shown and described. The multi-purpose light bulb includes at least one lighting element. The at least one lighting element is electrically coupled to an electrical connection. The electrically connection is electrically coupled to at least one speaker. The speaker and the lighting element are coupled such that the electrical connection will supply power to both at the same time. The multi-purpose light bulb further includes a wireless transceiver. The wireless transceiver is wirelessly connected to a device running an application that controls various aspects of the multi-purpose light bulb.

### CROSS REFERENCE TO RELATED APPLICATIONS

This application claims the benefit of U.S. Provisional Application No. 63/028,655 filed on May 22, 2020. The above identified patent application is herein incorporated by reference in its entirety to provide continuity of disclosure.

### BACKGROUND OF THE INVENTION

The present invention relates to light bulbs. More particularly, the present invention provides a multi-purpose light bulb that includes a wireless transceiver and a speaker.

Currently, many light bulbs are meant for a single purpose, providing light. While light bulbs serve this purpose well, they could be made to do more. For example, an adapted light could add features to vehicles. Currently, most vehicles are produced without any reverse warnings. This means that some people may be unaware when another vehicle is put in reverse. The reversing driver may seriously injure someone if other pedestrians are not paying attention. Without an audible alert, other drivers or pedestrians may not be able to tell when the vehicle is reversing.

Consequently, there is a need for an improvement in the art of light bulbs. The present invention substantially diverges in design elements from the known art while at the same time solves a problem many people face when wanting a light bulb that produces sound. In this regard the present invention substantially fulfills these needs.

### SUMMARY OF THE INVENTION

The present invention provides a multi-purpose light bulb wherein the same can be utilized for providing convenience for the user when using a light bulb. The multi-purpose light bulb is comprised of at least one lighting element. The multi-purpose light bulb further comprises at least one speaker, wherein the speaker is wired to emit a sound when the light bulb is activated. Further, the multi-purpose light bulb includes an electrical connection, wherein the electrical connection will electrically couple the multi-purpose light bulb to a power source.

Another object of the multi-purpose light bulb is to provide a wireless transceiver electrically connected to the electrical connection, the at least one lighting element, and the at least one speaker.

Another object of the multi-purpose light bulb is to provide at least one lighting element that is an LED light.

Another object of the multi-purpose light bulb is to provide at least one lighting element that is a filament light.

Another object of the multi-purpose light bulb is to provide a light globe.

Another object of the multi-purpose light bulb is to provide an electrical connection that is configured to secure to the reverse light connection of a motor vehicle.

Another object of the multi-purpose light bulb is to provide a lighting element that has an adjustable brightness.

Another object of the multi-purpose light bulb is to provide an application, wherein the application is run on a device connected to the multi-purpose light bulb via the wireless transceiver.

Another object of the multi-purpose light bulb is to provide an application which controls the brightness of the light element.

Another object of the multi-purpose light bulb is to provide an application which controls the color of the light element.

Another object of the multi-purpose light bulb is to provide an application which controls the sound type emitted from the at least one speaker.

Another object of the multi-purpose light bulb is to provide an application which controls the volume of the sound emitted from the at least one speaker.

Another object of the multi-purpose light bulb is to provide an application which controls the sequence of illumination of the light element.

Another object of the multi-purpose light bulb is to provide an application which individually activates the lighting element.

Another object of the multi-purpose light bulb is to provide an application which individually activates the at least one speaker.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the multi-purpose light bulb.

FIG. 2 shows a wiring diagram of an embodiment of the multi-purpose light bulb.

FIG. 3 shows a perspective view of an embodiment of a mobile application to alter light bulb characteristics.

FIG. 4 shows a connection diagram of an embodiment of the multi-purpose light bulb installed within a vehicle.

FIG. 5 shows an in-use view of an embodiment of the multi-purpose light bulb.

### LIST OF REFERENCE NUMERALS

With regard to the reference numerals used, the following numbering is used throughout the drawings.
101 Electrical Connection
102 Speaker
103 Lighting element
104 Globe
201 Wireless transceiver
300 Mobile device
301 Speaker activation selector
302 Speaker volume
303 Sound selector
304 Light brightness
305 Light color
306 Light selector
401 Vehicle
402 Vehicle CPU
403 Vehicle power
404 Vehicle reverse light receptacle
405 CPU
501 Vehicle

### DETAILED DESCRIPTION OF THE INVENTION

Reference is made herein to the attached drawings. Like reference numerals are used throughout the drawings to depict like or similar elements of the multi-purpose light bulb. For the purposes of presenting a brief and clear description of the present invention, a preferred embodiment will be discussed as used for the multi-purpose light bulb. The figures are intended for representative purposes only and should not be considered to be limiting in any respect.

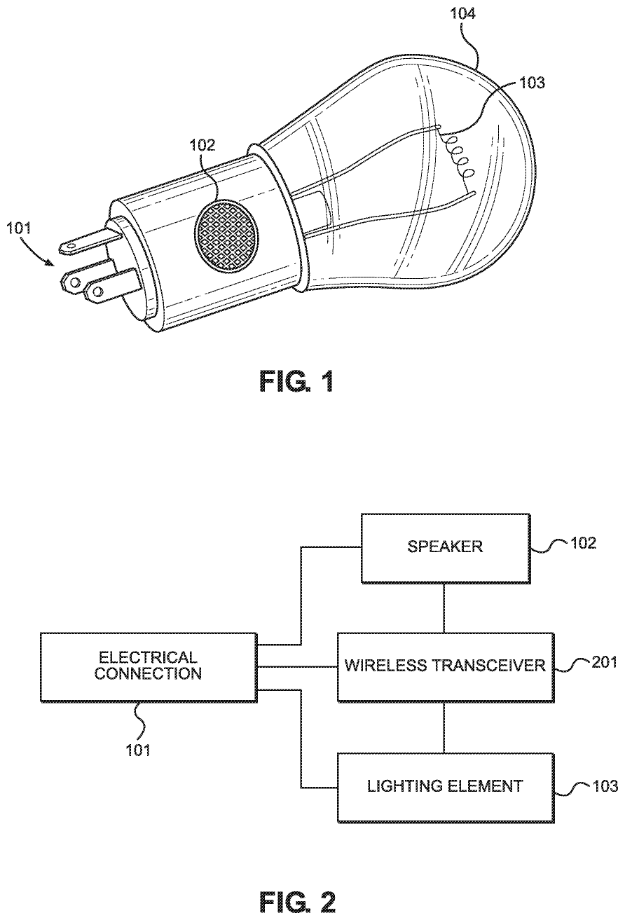

Referring now to FIG. 1, there is shown a perspective view of an embodiment of the multi-purpose light bulb. The multi-purpose light bulb includes an electrical connection 101. The electrical connection 101 will secure the multi-purpose light bulb to a power source. In the shown embodiment, the electrical connection 101 is a pronged connection. In one embodiment, the electrical connection 101 is configured to secure to a motor vehicle. In another embodiment, the electrical connection 101 is a screw connection for a home socket. In another embodiment, the electrical connection 101 is another form of acceptable connection to secure power to the multi-purpose light bulb.

The multi-purpose light bulb further includes at least one speaker 102. The at least one speaker 102 is configured to output at least one sound sequence. In one embodiment, there are several speakers 102 secured to the multi-purpose light bulb. This will increase the volume output.

The multi-purpose light bulb further includes at least one lighting element 103. In the shown embodiment, the at least one lighting element 103 is a filament lighting element. In other embodiments, there are multiple lighting elements 103. This will increase light output. In a further embodiment, the at least one lighting element 103 is an LED light. In some embodiments, there are multiple LED lights. This will also allow for redundancies in case of one or more light failures. In other embodiments the LED lights are in different colors.

Further, in one embodiment, there is a globe 104 surrounding the at least one lighting element 103. In some embodiments, the globe 104 is necessary. For example, when the lighting element 103 is a filament lighting element, the globe 104 provides a vacuum chamber therein. In other embodiments, the globe 104 is an optional addition. In one embodiment, the globe 104 is colored. This will allow the lighting element 103 to emit a colored light. In another embodiment, there are multiple different colored globes 104. This will allow the multi-purpose light to emit lights of different colors.

Referring now to FIG. 2, there is shown a wiring diagram of an embodiment of the multi-purpose light bulb. The electrical connection 101 is connected to the at least one speaker 102 and the at least one lighting element 103. In one embodiment, when power is added via the electrical connection 101, both the at least one speaker 102 and the at least one lighting element 103 will activate simultaneously. In another embodiment, the at least one lighting element 103 and the at least one speaker 102 are activated individually once power is received. This will allow for the speaker to be activated without light. In the alternative this will allow for the light to be activated without sound. This will allow an individual to use the light without always requiring a sound to play.

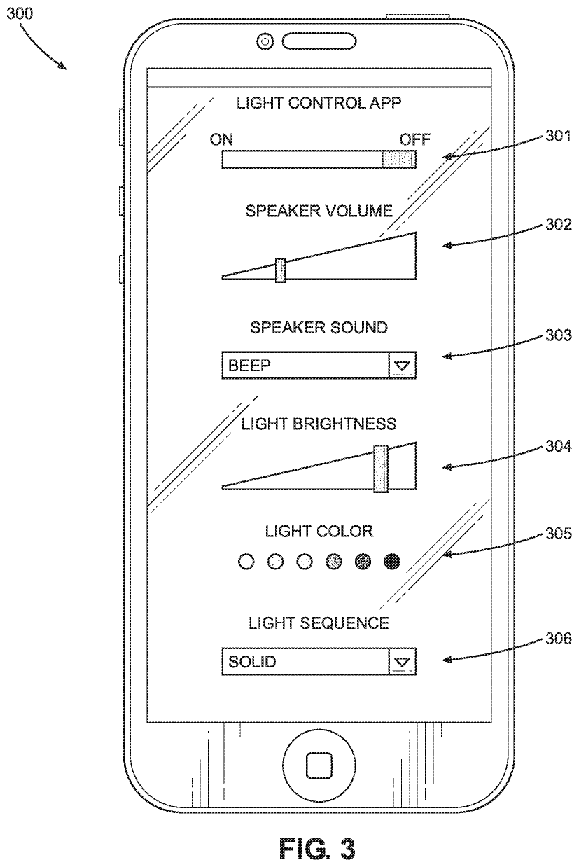

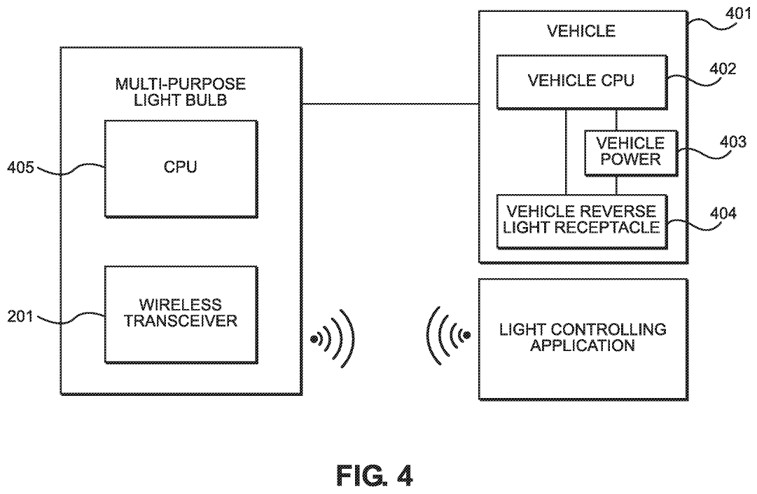

In one embodiment, there is a wireless transceiver 201 electrically connected within the multi-purpose light bulb. In one embodiment, the wireless transceiver 201 is connected directly to the at least one speaker 102. In another embodiment, the wireless transceiver 201 is connected directly to the at least one lighting element 103. In yet a different embodiment, as shown in FIG. 4, the wireless transceiver 201 is connected to a CPU which is in turn connected to the at least one speaker 102 and the at least one lighting element 103. The wireless transceiver 201 will connect to a device running a control application as described in the description of FIG. 3.

Referring now to FIG. 3, there is shown a perspective view of an embodiment of a mobile application to alter light bulb characteristics. In one embodiment, the multi-purpose light bulb has a plurality of settings that may be changed by a user. In one embodiment, the plurality of settings are controlled by a controlling application run on a connected device 300. In one embodiment, the connected device 300 is a mobile device. In one embodiment the mobile device is a cellular phone. In another embodiment the mobile device is a tablet. In yet a further embodiment the mobile device is a laptop.

In one embodiment, the application has the ability to turn the multi-purpose light bulb on or off 301. In one embodiment, the lighting element and the speaker have individual activation settings selections. In another embodiment, the control application includes a speaker volume control 302. This will allow the volume of the speaker to be adjusted to match a given environment. For example, in situations where a loud noise may be inappropriate, the volume can be lowered or muted. In yet a further embodiment, the control application has the ability to select the sound which the speaker plays 303. In one embodiment, the selection is selected from a drop-down menu of preset sounds. In a further embodiment, custom sounds may be selected. In one embodiment custom sounds may be recorded and saved. In another embodiment custom sounds may be selected from a drop down list. In yet a further embodiment, the speaker is instructed to play music form a source desired by the user. In one embodiment the source is a media playing application. In another embodiment the source is a radio.

The control application can further control the lighting element. In one embodiment, the brightness of the lighting element 304 can be controlled. This will allow a user to dim the lighting element if desired. In a further embodiment, the control application will allow for a selection of various light colors 305. In one embodiment the lights will be the results of different light bulbs as described in FIG. 1. This will allow for a user to select a color of the lighting element. In one embodiment, the lighting element color is selected from a list of preset colors. In another embodiment, the user can customize the color.

In yet a further embodiment, the control application further controls the light sequence 306. In one embodiment, the light sequence 306 is a solid output of light. In another embodiment, the lighting element is a strobe output of light. In one embodiment, the light sequence 306 is selected from a preset dropdown list. In yet a further embodiment, the light sequence 306 is a custom sequence.

Referring now to FIG. 4, there is shown a connection diagram of an embodiment of the multi-purpose light bulb installed within a vehicle. In one embodiment, the multi-purpose light bulb is electrically connected to a motor vehicle 401. In one embodiment, the motor vehicle 401 includes a vehicle CPU 402. The vehicle CPU 402 is connected to a vehicle power source 403 and a vehicle reverse light receptacle 404. The vehicle CPU 402 will send a signal to the reverse light receptacle 404 to allow power throughput when the vehicle 401 is in reverse.

The multi-purpose light bulb is then secured within the vehicle reverse light receptacle 404. In the shown embodiment the wireless transceiver 201 is connected to a CPU 405. The CPU 405 is then coupled to the at least one lighting element and the at least one speaker. This will allow the CPU 405 to store the lighting sequence and/or sound selection as described in the description of FIG. 3. The wireless transceiver 201 is further wirelessly coupled to a device running the control application. This will allow presets to be sent from the control application to the multi-purpose light bulb.

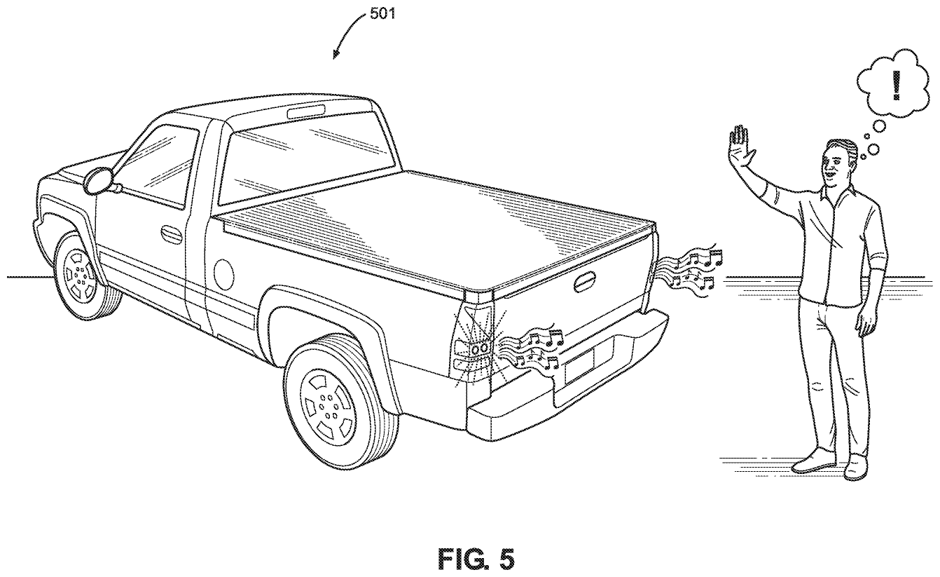

Referring now to FIG. 5, there is shown an in-use view of an embodiment of the multi-purpose light bulb. In one embodiment, the multi-purpose light bulb is connected into a vehicle 501. When the vehicle 501 is placed in reverse, the at least one lighting element is activated. This light is not always enough to alert surrounding individuals of a vehicle 501 in reverse. In this embodiment, when the vehicle 501 is placed in reverse, the at least one speaker is also activated. The sound from the at least one speaker will help to alert individuals in the surrounding area of a reversing vehicle 501. This will allow the individuals to vacate the area if they are in the vehicle's 501 path. In this manner, accidents are prevented by alerting individuals of a reversing vehicle 501 that otherwise would not have a sound element included in the reverse lights.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A multi-purpose light bulb, the light bulb comprising:
a base;
the base further comprising a pair of opposing ends and a central body;
at least one lighting element;
the at least one lighting element is disposed on a first opposing end of the base;
at least one speaker, wherein the speaker is wired to emit a sound when the light bulb is activated;
the at least one speaker is disposed on the central body of the base;
an electrical connection, wherein the electrical connection will electrically couple the multi-purpose light bulb to a power source; and
the electrical connection is disposed on a second opposing end of the base.

2. The multi-purpose light bulb of claim 1, wherein the at least one lighting element is an LED light.

3. The multi-purpose light bulb of claim 1, wherein the at least one lighting element is a filament light.

4. The multi-purpose light bulb of claim 3, further comprising a light globe.

5. The multi-purpose light bulb of claim 1, wherein the electrical connection is configured to secure to the reverse light connection of a motor vehicle.

6. The multi-purpose light bulb of claim 1, wherein the lighting element has an adjustable brightness.

7. A multi-purpose light bulb, the light bulb comprising:
a base;
the base further comprising a pair of opposing ends and a central body;
at least one lighting element;
the at least one lighting element is disposed on a first opposing end of the base;
at least one speaker, wherein the speaker is wired to emit a sound when the light bulb is activated;
the at least one speaker is disposed on the central body of the base;
an electrical connection, wherein the electrical connection will electrically couple the multi-purpose light bulb to a power source;
the electrical connection is disposed on a second opposing end of the base; and
a wireless transceiver electrically connected to the electrical connection, the at least one lighting element, and the at least one speaker.

8. The multi-purpose light bulb of claim 7, wherein the at least one lighting element is an LED light.

9. The multi-purpose light bulb of claim 7, wherein the at least one lighting element is a filament light.

10. The multi-purpose light bulb of claim 9, further comprising a light globe.

11. The multi-purpose light bulb of claim 7, wherein the electrical connection is configured to secure to the reverse light connection of a motor vehicle.

12. The multi-purpose light bulb of claim 7, wherein the lighting element has an adjustable brightness.

13. The multi-purpose light bulb of claim 7, further comprising an application, wherein the application is run on a device connected to the multi-purpose light bulb via the wireless transceiver.

14. The multi-purpose light bulb of claim 13, wherein the application controls the brightness of the light element.

15. The multi-purpose light bulb of claim 13, wherein the application controls the color of the light element.

16. The multi-purpose light bulb of claim 13, wherein the application controls the sound type emitted from the at least one speaker.

17. The multi-purpose light bulb of claim 13, wherein the application controls the volume of the sound emitted from the at least one speaker.

18. The multi-purpose light bulb of claim 13, wherein the application controls the sequence of illumination of the light element.

19. The multi-purpose light bulb of claim 13, wherein the application individually activates the lighting element.

20. The multi-purpose light bulb of claim 13, wherein the application individually activates the at least one speaker.
